(19) United States
(12) Patent Application Publication
(10) Pub. No.: US 2013/0199576 A1
(43) Pub. Date: Aug. 8, 2013

(54) SYSTEM AND METHOD TO CLEAR A LIQUID FUEL SUPPLY LINE

(71) Applicants: David Clayton Poole, Atlanta, GA (US); Alston Ilford Scipio, Mabelton, GA (US)

(72) Inventors: David Clayton Poole, Atlanta, GA (US); Alston Ilford Scipio, Mabelton, GA (US)

(73) Assignee: GENERAL ELECTRIC COMPANY, Schenectady, NY (US)

(21) Appl. No.: 13/366,859

(22) Filed: Feb. 6, 2012

(51) Int. Cl. B08B 9/032; B08B 5/00; B08B 3/04

(52) U.S. Cl. 134/22.12; 134/166 C

(57) ABSTRACT

A system to clear a liquid fuel supply line in a turbomachine includes a valve configured to control a flow of cleanser into the liquid fuel supply line. The system also includes a controller configured to control the valve to allow the flow of cleanser when liquid fuel is not being supplied to a combustion can of the turbomachine through the liquid fuel supply line.

### BACKGROUND OF THE INVENTION

The subject matter disclosed herein relates to clearing liquid fuel supply lines in a turbomachine.

Heavy-duty turbomachines can run on natural gas but are required to have dual fuel capacity such that an alternate fuel source, such as liquid fuel, can also be used to mitigate down time of the turbomachine. Because some turbomachines predominantly run on natural gas, the liquid fuel lines, which are typically used less often, can become clogged. Residual liquid fuel can become trapped in the line and, because of the high temperatures within the turbomachine enclosure when the turbomachine is operating on natural gas or shutdown, the trapped liquid fuel can form coke that clogs orifices such as the fuel nozzles and causes valves to stick in an open, closed, or intermediate position. As a consequence, liquid fuel may not be delivered sufficiently or timely in subsequent liquid fuel mode operation of the turbomachine.

In previous systems, attempted solutions to the problem have been inefficient and costly. For example, one part of the liquid fuel line (check valve) may be water-cooled to prevent its sticking in an open, closed, or intermediate position. However, this solution does not address other parts of the liquid fuel line, such as the flow divider. As another example, a blast of nitrogen has been used to purge/drain/blowdown the liquid fuel lines. However, this is a costly solution that necessitates a modification to existing systems. Another costly solution has been the inclusion of a return line such that liquid fuel continuously circulates through the liquid fuel line; however, this system does not clean the fuel nozzles or flow dividers when the machine is not operating on liquid fuel. The costs associated with this solution include parasitic energy loss due to the operation of the circulation pumps. A low-cost and effective system and method to clear the liquid fuel supply line would be appreciated in the dual fuel turbomachine industry.

### BRIEF DESCRIPTION OF THE INVENTION

According to an aspect of the invention, a system to clear a liquid fuel supply line in a turbomachine includes a valve configured to control a flow of cleanser into the liquid fuel supply line; and a controller configured to control the valve to allow the flow of cleanser when liquid fuel is not being supplied to a combustion can of the turbomachine through the liquid fuel supply line.

According to another aspect of the invention, a method of clearing a liquid fuel supply line in a turbomachine includes stopping a supply of liquid fuel to the turbomachine; and controlling a flow of a cleanser into the liquid fuel supply line when liquid fuel is not being supplied to a combustion can of the turbomachine.

According to yet another aspect of the invention, a computer-readable medium stores instructions which, when processed by a processor, cause the processor to execute a method of clearing a liquid fuel supply line in a dual fuel turbomachine. The method includes stopping a supply of liquid fuel to the turbomachine; and controlling a flow of a cleanser into the liquid fuel supply line when liquid fuel is not being supplied to a combustion can of the turbomachine.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts aspects of a turbomachine according to an embodiment of the invention;

FIG. 2 is a block diagram of a controller of the liquid fuel supply line clearing system according to an embodiment of the invention; and

FIG. 3 illustrates the processes included in clearing a liquid fuel supply line 110 according to an embodiment of the invention.

The detailed description explains embodiments of the invention, together with advantages and features, by way of example with reference to the drawings.

### DETAILED DESCRIPTION OF THE INVENTION

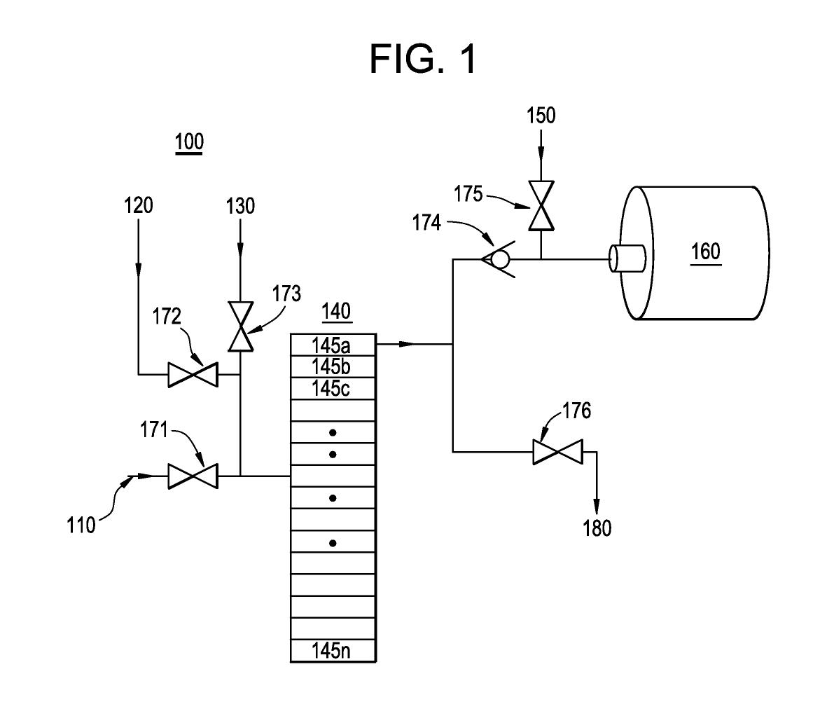

FIG. 1 depicts aspects of a turbomachine 100 according to an embodiment of the invention. The liquid fuel supply line 110 supplies liquid fuel to a flow divider 140 based on a position of the valve 171. The flow divider 140 divides the liquid fuel flow equally between a number of flows 145. In an F-class turbine, for example, the flow divider 140 may divide liquid fuel flow into 6-18 flows 145a-145n. Each flow 145 supplies a different combustion can 160. For ease of understanding, only one flow 145a and corresponding combustion can 160 are shown by FIG. 1. The gas supply to the combustion can 160 is not shown because it does not relate to embodiments of the invention. Also, the water injection line to the combustion can 160 is not shown. Water injection is utilized during turbomachine operation on liquid fuel for emission (NOx) control and flame stabilization. However, it should be understood that, in a dual fuel turbomachine 100, each combustion can 160 includes a supply line for gas, liquid fuel, and injection water.

When the combustion can 160 is supplied with gas, the valve 171 is closed to prevent the liquid fuel supply line 110 from supplying liquid fuel to the combustion can 160 at the same time. During this down time for the liquid fuel supply, pockets of residual liquid fuel may pool in various areas along the liquid fuel supply line 110. Purge air 150 is let into the combustion can 160 by opening the valve 175 during gas fired operation. The purge air 150 keeps the liquid fuel nozzle in the combustion can 160 cool when the combustor is firing based on a gas supply. The cooling of the nozzle within the combustion can 160 notwithstanding, the residual liquid fuel in the liquid fuel supply line 110 is heated because of the high temperature combustion in the combustion can 160 or otherwise by the surrounding air temperature in proximity to the turbomachine. The heated residual liquid fuel forms coke (petcoke) that clogs orifices (such as the nozzle for the liquid fuel supply line 110 into the combustion can 160). The coke also sticks to the internals of the 3-way valve or check valve 174. When the check valve 174 is formed as a plunger and seat, the coke may cause the plunger to be stuck to the seat such that the check valve 174 cannot open when liquid fuel is called for again. The coke may also cause the check valve 174 to be stuck open. In this case, the next time liquid fuel is called for, the flow 145 associated with the already-open check valve 174 will allow an uncontrolled supply of liquid fuel to its corresponding combustion can 160 than via other flows 145. The resulting non-uniform timing among the flows 145 of the flow divider 140 will cause a trip (or failure to operate) at startup or a failed transfer from operation on gas fuel to liquid fuel of the turbomachine 100. Also, if the coke causes the check valve 174 to remain only partially open, then, in addition to faster supply, the effected flow 145 will ultimately provide a smaller supply of liquid fuel to its corresponding combustion can 160.

According to an embodiment of the present invention, a cleanser 130 is introduced into the liquid fuel supply line 110 followed by one or more puffs of instrument air 120 to push the cleanser 130 through the liquid fuel supply line 110. The cleanser 130 is introduced into the liquid fuel supply line 110 by opening the valve 173 when the liquid fuel is not flowing in the liquid fuel supply line 110 (when valve 171 is closed and the turbomachine is operating in gas mode or is not operating at all). In one embodiment, the cleanser 130 is water. Using water as the cleanser 130 presents a low-cost solution because demineralized water is already on site for the boiler of a combined cycle system, for example. Additionally, water is injected into the combustion can 160 along with liquid fuel for emission reduction (to suppress nitrous oxide (NOx)) in a liquid fuel system.

In an alternate embodiment, steam, rather than water, may be used as the cleanser 130. Steam may be better especially during the turbomachine's operation on gas input to ensure that the combustion process is not negatively affected. Further, when the cleanser 130 is steam, the instrument air 120 may not be needed. Additionally, steam is injected into the combustion can 160 for emission reduction (to suppress NOx). In yet another embodiment, another liquid, other than water, may be used as the cleanser 130. A suitable liquid is any liquid that does not leave its own residue in the liquid fuel supply line 110. The residual liquid fuel and coke that is flushed out of the flow divider 140, check valve 174, and remainder of the liquid fuel supply line 110 can be drained out of the system by opening the valve 176 to the waste oil drain 180.

FIG. 1 shows a single inlet for the cleanser 130 into the liquid fuel supply line 110. However, a header system to permit more than one inlet, as well as different locations along the liquid fuel supply line 110 for the inlet, are also contemplated. The control of the various valves (e.g., 171, 172, 173, 174, 176) to clear the liquid fuel supply line 110 may be manual. In an alternate embodiment, the control may be automated and may be integrated with other controls of the turbomachine and to facilitate embodied cleansing of the liquid fuel lines post liquid fuel operation and when the turbomachine is not in operation

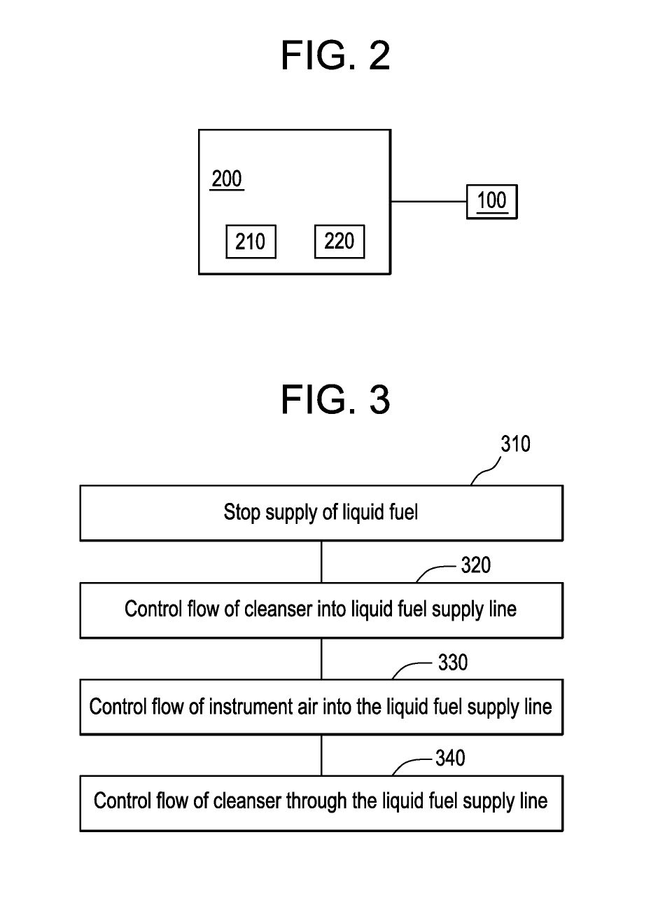

FIG. 2 is a block diagram of a controller 200 of the liquid fuel supply line 110 clearing system according to an embodiment of the invention. The clearing system includes the cleanser 130, instrument air 120, and various valves (e.g., 171, 172, 173, 174, 176) for each of the flows 145, as discussed with reference to FIG. 1. The controller 200 includes one or more processors 210 and one or more memory devices 220 that may be integrated with one or more control systems of the turbomachine 100 or may be housed separately and in communication with the control system(s) of the turbomachine 100. The one or more memory devices 220 of the controller 200 store the control instructions that are processed by the one or more processors 210 to implement control. The controller 220 keeps valve 171 closed when the turbomachine is non-operational or is operating with gas input. The controller 200 opens valve 173 to allow cleanser 130 into the liquid fuel supply line 110 and then closes valve 173 and opens valve 172 briefly to allow instrument air in to push the cleanser 130 through. The controller 200, alone or in combination with one or more control systems of the turbomachine 100 also controls the check valve 174 and valve 176 that leads to the waste oil drain 180 to rid the liquid fuel supply line 110 of residual liquid fuel and coke. For example, to clear the flow divider 140, the controller 200 may close the check valve 174 and open the valve 176 to drain any residual liquid fuel and coke to the waste oil drain 180. To clear the check valve 174, as well, the controller 200 may close the valve 176 and open the check valve 174, allowing the cleanser 130 and instrument air 130 all the way through to the combustion can 160.

FIG. 3 illustrates the processes 300 included in clearing a liquid fuel supply line 110 according to an embodiment of the invention. At block 310, stopping the supply of liquid fuel includes closing valve 171 or controlling a different means of flow control to stop the supply of liquid fuel to the turbomachine 100. At block 320, controlling the flow of cleanser 130 into the liquid fuel supply line 110 includes controlling the valve 173 or a different means of flow control. The controlling at block 320 may further include sequencing to allow the cleanser 130 into the liquid fuel supply line 110 by opening the valve 173 to let in some cleanser 130 and then closing the valve 173 to stop the supply of cleanser 130 into the liquid fuel supply line 110, for example. At block 330, controlling the flow of instrument air 120 into the liquid fuel supply line 110 includes controlling the valve 172 or a different means of flow control. The controlling at block 330 may further include sequencing for allowing the instrument air 120 the liquid fuel supply line 110 by opening the valve 172 to let in some instrument air 120 and then closing the valve 172 to stop the supply of instrument air 120 into the liquid fuel supply line 110, for example. When the cleanser 130 is steam, controlling the flow of instrument air 120 may include sequencing to not allow instrument air 120 into the liquid fuel supply line 110. For example, the controlling at block 330 may include leaving the valve 172 closed during process of clearing the liquid fuel supply line 110. At block 340, controlling the flow of cleanser 130 through the liquid fuel supply line 110 includes controlling valves along the liquid fuel supply line 110 includes controlling the check valve 174 and the valve 176 to the waste oil drain in the various ways discussed above. The sequencing or scheduling by the controller 200 ensures that any cleaning is scheduled at a load point in turbine operation that results in reduced disruption to operational stability and reduce the impact to component (hot gas path) life expectancy. In alternate embodiments, flow control means other than valves may be used. By executing the processes 300, the present invention has the technical effect of clearing the liquid fuel supply line 110 of residual liquid fuel and coke.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system to clear a liquid fuel supply line in a turbomachine, the system comprising:
a valve configured to control a flow of a cleanser into the liquid fuel supply line; and
a controller configured to control the valve to allow the flow of cleanser when liquid fuel is not being supplied to a combustion can of the turbomachine through the liquid fuel supply line.

2. The system according to claim 1, wherein the turbomachine is a dual fuel turbomachine, and the controller controls the valve to allow the flow of cleanser when natural gas is being supplied to the combustion can of the turbomachine.

3. The system according to claim 1, wherein the cleanser is water.

4. The system according to claim 1, further comprising:
a second valve configured to control a flow of instrument air into the liquid fuel supply line, wherein
the controller is further configured to control the second valve to allow the flow of instrument air after the flow of cleanser.

5. The system according to claim 1, wherein the cleanser is steam.

6. The system according to claim 1, wherein the controller controls the valve to allow the flow of the cleanser when the turbomachine is operating in a gas fuel mode.

7. The system according to claim 1, wherein the cleanser is any liquid that flows through the liquid fuel supply line without leaving a residue.

8. The system according to claim 1, wherein the controller controls the valve to allow the flow of the cleanser when the turbomachine is not operating.

9. The system according to claim 1, wherein the valve is upstream of a flow divider configured to divide liquid fuel in the liquid fuel supply line among a plurality of flows, each flow supplying a corresponding combustion can of the turbomachine.

10. The system according to claim 9, further comprising:
a third valve configured to control a flow to a waste drain, wherein
the controller is further configured to control the third valve to allow the flow to the waste drain when the flow divider of the liquid fuel supply line is being cleared.

11. A method of clearing a liquid fuel supply line in a turbomachine, the method comprising:
stopping a supply of liquid fuel to the turbomachine; and
controlling a flow of a cleanser into the liquid fuel supply line when liquid fuel is not being supplied to a combustion can of the turbomachine.

12. The method according to claim 11, wherein the turbomachine is a dual fuel turbomachine and the controlling the flow of the cleanser includes allowing the cleanser into the liquid fuel supply line when natural gas is being supplied to the combustion cans of the turbomachine.

13. The method according to claim 11, further comprising:
controlling a flow of instrument air into the liquid fuel supply line after the flow of the cleanser has been stopped.

14. The method according to claim 11, further comprising:
controlling the flow of the cleanser through the liquid fuel supply line and into a combustion can of the turbomachine.

15. The method according to claim 11, further comprising:
controlling the flow of the cleanser through the liquid fuel supply line to a waste drain.

16. A computer-readable medium that stores instructions which, when processed by a processor, cause the processor to execute a method of clearing a liquid fuel supply line in a turbomachine, the method comprising:
stopping a supply of liquid fuel to the turbomachine; and
controlling a flow of a cleanser into the liquid fuel supply line when liquid fuel is not being supplied to a combustion can of the turbomachine.
